(19) United States
(12) Patent Application Publication
(10) Pub. No.: US 2016/0000637 A1
(43) Pub. Date: Jan. 7, 2016

(54) Apparatus for Performing Manipulations of the Spine

(71) Applicant: Alan Shakarian, Youngstown, OH (US)

(72) Inventor: Alan Shakarian, Youngstown, OH (US)

(21) Appl. No.: 14/596,655

(22) Filed: Jan. 14, 2015

Related U.S. Application Data
(60) Provisional application No. 62/021,674, filed on Jul. 7, 2014.

(51) Int. Cl. A61H 7/00

(52) U.S. Cl. CPC A61H 7/003

(57) ABSTRACT

An apparatus comprises a contoured block comprising a sculpted palm rest on a top surface and a finger grip indentation on a front side. The contoured block is configured to be grasped by a hand of a user with fingers on the finger grip indentation and a palm on the sculpted palm rest where a thumb of the hand is extendable to guide placement of the apparatus on a patient's spine. Pads are disposed on a bottom surface of the contoured block. The pads are configured to form a spinal channel. The pads are further configured for contacting sides of the patient's spine with the patient's spine being positioned within the spinal channel.

### CROSS-REFERENCE TO RELATED APPLICATIONS

The present Utility patent application claims priority benefit of the [U.S. provisional application for patent Ser. No. 62/021,674, entitled “Apparatus for Performing Manipulations of the Spine” filed on 7 Jul. 2014 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to medical tools. More particularly, the invention relates to a hand guard for use when performing manipulations of the spine.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. In some applications involving the care and treatment of the musculoskeletal system, including, without limitation, chiropractic and osteopathy, anterior adjustments may be performed to manipulate the thoracic and/or lumbar spine. When performing an anterior adjustment, a practitioner may place his fist in a proper position along a patient's spine. Using the other arm, the practitioner usually embraces the patient's crossed arms and guides the patient down onto his fist. The practitioner may then apply a downward thrust, putting pressure on the crossed arms of the patient causing the practitioner's fist to press against the spine of the patient. This may have the effect of adjusting the spine of the patient at the location of the practitioner's fist by manipulating the facet joints of the spine, which may free up fixations in the thoracic region. Typically, the practitioner then brings the patient back up to sitting. In some cases the practitioner may then move his fist to multiple different portions of the spine, repeating the process until a full adjustment has been performed. One can expect that, a practitioner may experience wear and tear on his hands, specifically the knuckles of the dominant hand, from repetitive use during anterior adjustments. Furthermore, it is believed that some factors may lead to inability to effectively manipulate the spine including, without limitation, variations in patient body size, weight of the patient, and practitioner's hand size. In addition, the practitioner's knuckles pressing into the back of the patient when performing a proper anterior adjustment with the fist, may result in discomfort or tension in the patient and a less effective adjustment.

By way of educational background, another aspect of the prior art generally useful to be aware of is that some devices are currently available that are meant to aid a practitioner in performing an anterior adjustment. One such device utilizes a hollow, metal tunnel and two rubber pads on the bottom with a spine-shaped channel between. It is believed that this device is designed to perform the anterior adjustment with a flat, open hand, which may provide less depth than when using a fist according to the conventional way in which anterior adjustments are typically performed and taught. One may expect that the one-size-fits-all hollow tunnel design of this device may result in an irregular amount of control for some users. For example, without limitation, users with smaller hands may experience sliding and may need to stabilize the device by gripping the top edge of enclosure with the fingertips causing possible strain to the distal interphalangeal (DIP) joints or may need to spread fingers inside the device. It is believed that this device is intended to engage the thumb of the practitioner as a way of locating the spine for accuracy while using the device. However, due to the likelihood that the edge of the device's frame will rest between the thumb and index finger of the practitioner, it may be expected that the thumb's placement will typically fall below the spine channel and cause the over-extension of the thumb. This may decrease the practitioner's ability to seamlessly transition from locating the spine to positioning the device.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, 1C, 1D, 1E, and 1F illustrate an exemplary hand guard device for use when performing manipulations of the spine, in accordance with an embodiment of the present invention. FIG. 1A is a partially exploded side perspective view. FIG. 1B is a diagrammatic front view. FIG. 1C is a diagrammatic bottom view of the device in place within a hand. FIG. 1D is a front perspective view of the device being used to perform an anterior adjustment. FIG. 1E is a diagrammatic top view of the device on the fist, and FIG. 1F is a diagrammatic side view of the device in use for adjustment of a spine.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

One embodiment of the present invention provides a protective hand guard for a practitioner's use while performing a specific manipulation to the thoracic and/or lumbar spine. This embodiment is typically for use when performing an anterior adjustment and may be used by a multiplicity of suitable practitioners including, without limitation, Chiropractors, Osteopathic Doctors, and physical therapists etc.

Some embodiments may be able to level the field between users to help all chiropractors and other practitioners, regardless of differences in strength, hand size, or size of the patient, achieve effective movement of the spine when performing an anterior adjustment to the thoracic and/or lumbar regions of the spine. Some embodiments may comprise a contoured block, sculpted palm rest, finger grip indentation, protective ledge, and raised pads.

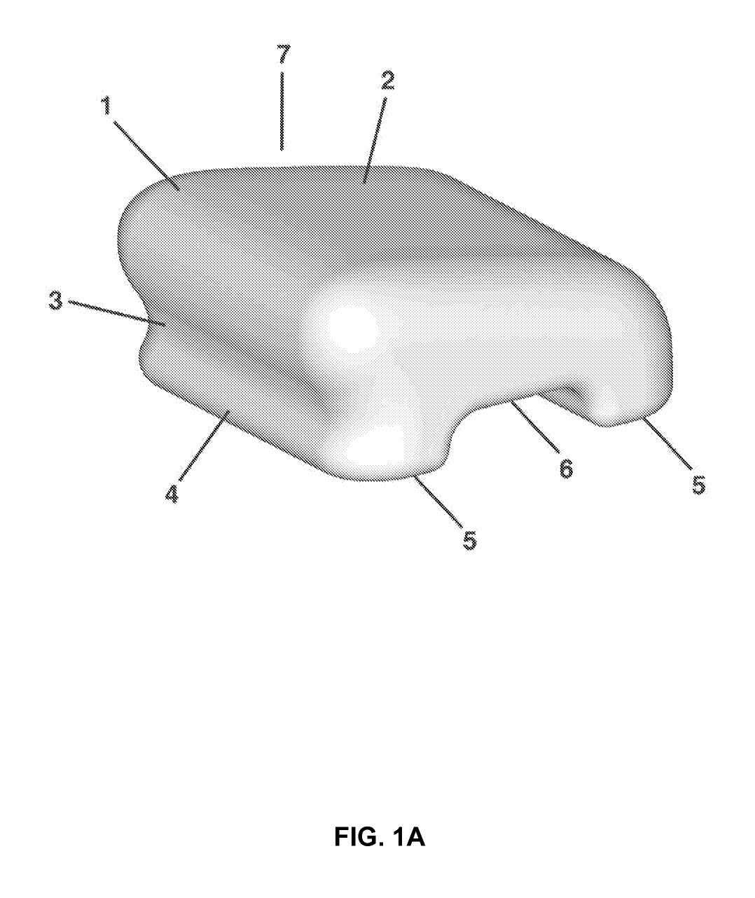

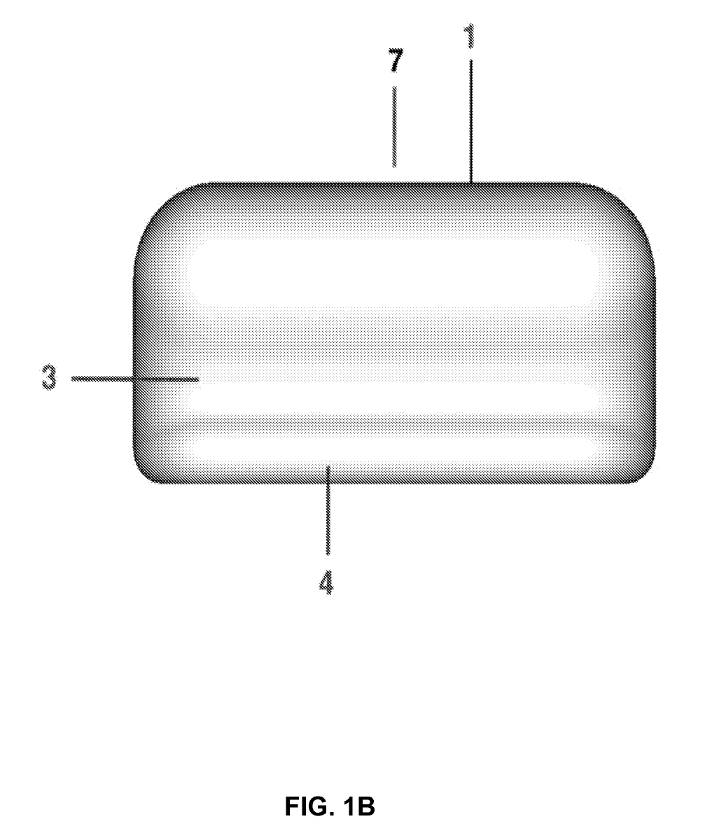

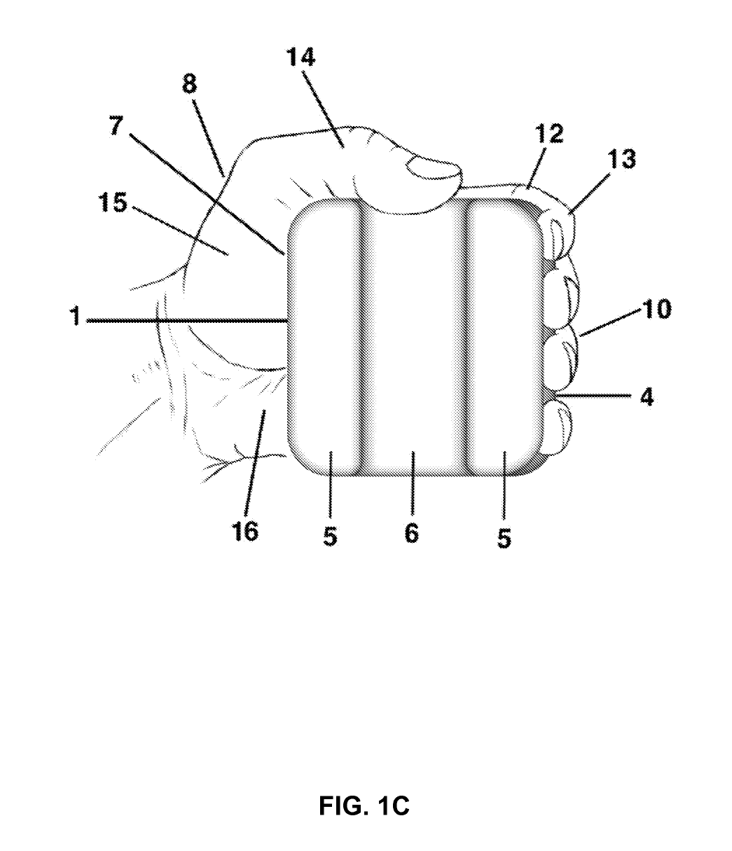

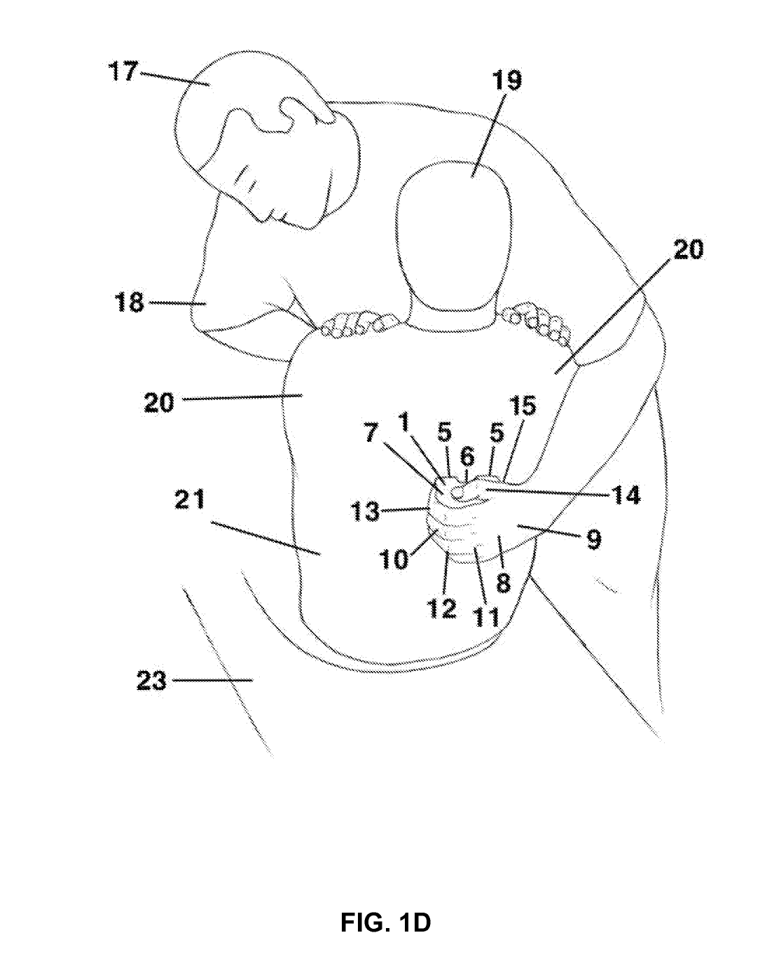

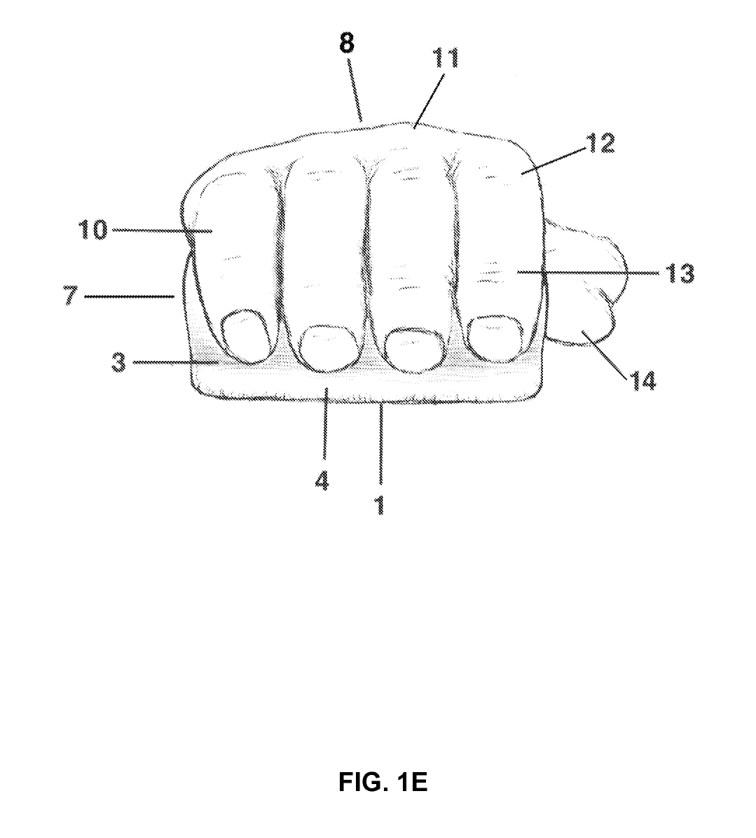

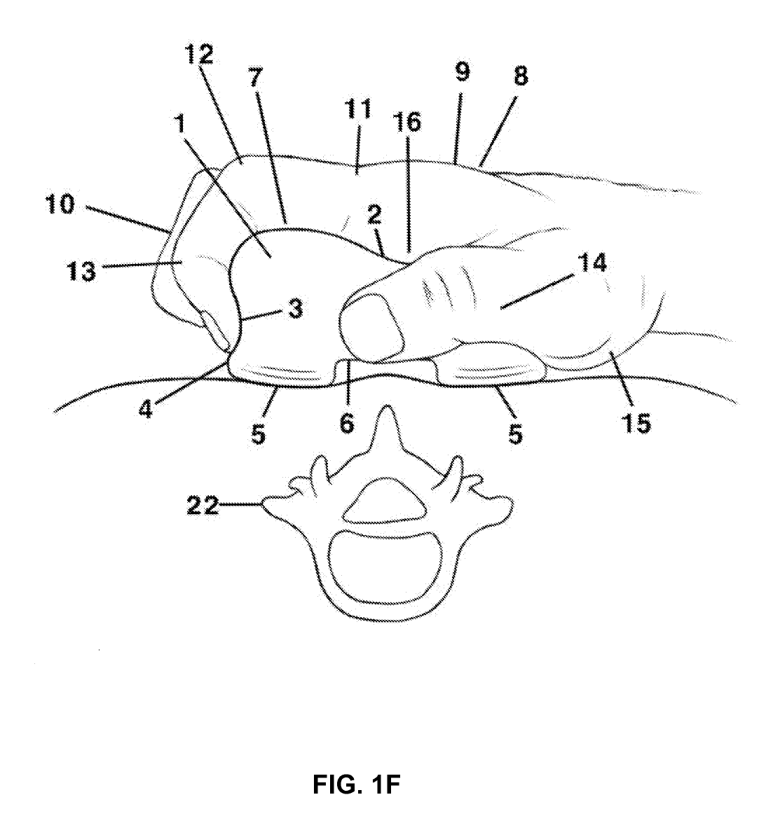

FIGS. 1A, 1B, 1C, 1D, 1E, and 1F illustrate an exemplary hand guard device (7) for use when performing manipulations of the spine, in accordance with an embodiment of the present invention. FIG. 1A is a partially exploded side perspective view. FIG. 1B is a diagrammatic front view. FIG. 1C is a diagrammatic bottom view of the device (7) in place within a hand (8). FIG. 1D is a front perspective view of device (7) being used to perform an anterior adjustment. FIG. 1E is a diagrammatic top view of device (7) within a hand (8), and FIG. 1F is a diagrammatic side view of device (7) in use for adjustment of a spine (22). In the present embodiment, device (7) comprises a contoured block (1) made of rubber or another suitable material that will flex, yet maintain its general shape under force such as, but not limited to, plastic, or silicone. In some embodiments, contoured block (1) may be made of a generally inflexible material such as fiberglass, carbon fiber, wood, metal, etc. and coated in a soft derometer material for added comfort. Contoured block (1) may be formed through a multiplicity of suitable means such as, but not limited to, molding, or 3D printing. Contoured block (1) comprises a sculpted palm rest (2), finger grip indentation (3), protective ledge (4), raised bottom pads (5), and spine chamber (6). Present embodiment is all one piece, however some embodiments may be comprised of individual components joined or fused together through the use of adhesives or some other process. In some embodiments contoured block may be custom molded to fit the unique hand shape of practitioner or be comprised of individual components which have been custom molded. Referring to FIG. 1F, the practitioner (17) grips the contoured block (1) by setting the open palm of the hand (8) onto the sculpted palm rest (2) and curving the fingers (10), placing them inside the finger grip indentation (3) along the front edge of the contoured block (1) with thumb (14) resting on the side. Some embodiments may be implemented without finger grip indentation or with multiple indentations for one or more fingers. Some other embodiments may utilize a gradual slope as a palm rest rather than the ergonomic design of present embodiment.

Referring to FIG. 1D, a practitioner (17) is shown performing an anterior adjustment on a patient (19) using device (7). Referring to FIGS. 1A, 1D and 1F, in the present embodiment, the device (7) consists of a contoured block (1) ergonomically shaped to rest inside the palm (16) of either hand (8) while being gripped by placing fingers (10) inside a finger grip indentation (3) along the front edge of the contoured block (1) above a small protective ledge (4) formed by the side of one of the raised pads (5) while thumb (14) rests along the device's side allowing the back of the practitioner's hand (9) and metacarpophalangeal (MCP) joints (11) to lie flat against the practitioner's table (23) providing a larger surface for more even distribution of the patient's weight while alleviating compression of the proximal interphalangeal (PIP) (12) and distal interphalangeal (DIP) joints (13) which typically remain bent under the weight of the patient in a conventional anterior adjustment. In some embodiments, the size of the contoured block (1) may vary in order to accommodate hands of different sizes. In the present embodiment, two raised pads (5) placed on either side of the contoured block's bottom, and contoured block are made from one piece of medium derometer rubber. Raised pads (5) and spinal chamber (6) cover entire bottom surface of the contoured block (1) to imitate practitioner's fist, specifically, fingers (10) and heel of hand (15) as positioned in a conventional anterior adjustment performed with no assistive device. Referring to FIGS. 1A, 1C, and 1F, raised pads (5) typically form a flat channel (6) down the middle to house spine (22), which is believed to provide even distribution of pressure and comfortable application of force to the patient's back (21), so that the patient may more easily relax. Raised pads (5) comprise a flat surface. In some embodiments the raised pads may comprise raised portions in various different patterns such as, but not limited to, nubs, strips or waves, to aid in providing tactile feedback and stimulation to the patient. In the present embodiment, raised pads (5) may be made from a variety of suitable materials including, without limitation, foam, silicone or rubber. Some embodiments may alternatively comprise two separate foam, rubber, or silicone pads connected to the contoured block through the use of adhesive, hook and loop material, snaps, or other attachment means. Some embodiments may comprise removable interchangeable raised pads of varying derometer or thickness.

Referring to FIGS. 1D, 1E, and 1F, in typical use of the present embodiment, practitioner (17) grips device (7) by placing fingers (10) into the finger grip indentation (3) along the front side of device (7) which typically causes back of the hand (9) and metacarpophalangeal (MCP) joints (11) to lie flat against the practitioner's table (23) providing a larger surface for more even distribution of the patient's weight while fingers (10) wrap around contoured block (1) with proximal interphalangeal (PIP) (12) and distal interphalangeal (DIP) (13) joints extended and shielded from compression by protective ledge (4). Practitioner (17) may then extend thumb (14). With patient (19) sitting lengthwise on the practitioner's table (23), patient (19) may then tightly cross his arms (20) as practitioner (17) places his thumb (14) along spine (22) to guide device (7) into the proper position on back of patient (21) so that spine (22) rests within channel (6) between raised pads (5) on bottom of device (7). Once device (7) is positioned properly, practitioner (17) may set his thumb (14) in a resting position alongside contoured block (1). Then, using his other arm (18), practitioner (17) embraces the patient's crossed arms (20). Patient (19) then typically takes a deep breath and, at the end of exhalation, is guided down by practitioner (17) onto device (7). Practitioner (17) then applies a downward thrust, putting pressure on crossed arms (20) of patient (19), which typically causes raised pads (5) on bottom of device (7) to press along both sides of spine (22). This typically produces a posterior to anterior (or front to back) force which manipulates the facet joints of the spine (22), which may free up fixations in the thoracic region of spine (22). Practitioner (17) then brings patient (19) back up to sitting, and may move device (7) up or down spine (22) to a different position and repeat the process by embracing and guiding patient (19) down onto device (7) after each movement until a full adjustment has been performed.

In the present embodiment, device (7) may provide comfort for both practitioner (17) and patient (19) during the manipulation. For patient (19), raised pads (5) along the bottom of device (7) typically cushion the area along spine (22) thereby generally avoiding the natural discomfort and tension caused by a conventional anterior adjustment as the practitioner's finger joints/knuckles (11-13) press into the muscle. One may expect that this may allow patient (19) to relax, which may result in more movement during the adjustment even in the lower lumbar area as well as potentially preventing injuries to patient (19) such as, but not limited to, sprains and strains due to tensing of back muscles. Device (7) may also provide comfort to practitioner (17) while providing an effective adjustment for patient (19) since contoured block may act as a thick fist while remaining moderately flexible to generally prevent compression when placed between the thoracic or lumbar spine (22) of patient (19) and practitioner's table (23). Moderate flexibility of contoured block (1) may help device (7) maintain its general shape and depth even when adjusting larger patients regardless of the hand size of practitioner (17). For practitioner (17), the contoured block (1) fits practitioner's hand (8) using a sculpted palm rest (2) and a finger grip indentation (3) to position the hand (8) so that it remains partially open. This prevents compression of the proximal interphalangeal (PIP) joints (12) and distal interphalangeal (DIP) joints (13) which typically remain bent under the weight of the patient in a conventional anterior adjustment performed using a fist. While gripping contoured block (1), the back of practitioner's hand (9) and metacarpophalangeal (MCP) joints (11) lie flat against the table (23) providing a larger surface for more even distribution of patient's weight. Contoured block (1) design provides both the necessary depth and stability to properly manipulate the thoracic or lumbar spine of patient (19) while utilizing raised pads (5) and spinal chamber (6) to imitate the heel (15) and bent fingers (10) of a fist. Allowing practitioner's hand (8) to remain partially open around the contoured block (1) may offer protection from possible repetitive stress on joints (11, 12, 13) and portions of the hand (8), which could lead to degenerative joint arthritis from years of wear and tear while doing this particular type of chiropractic manipulation. Furthermore, contoured block (1) is typically ergonomically suited for the use of either hand (8) and may enable device (7) to easily transfer from one hand (8) to the other for ambidextrous use, which may help to prevent overuse. Moreover, the open sides may also allow for the use of thumb (14) as a guide to locate spine (22).

One prior art device utilizes a hollow tunnel into which a practitioner may insert a flat open hand for application of an anterior adjustment, which, as a one-size-fits-all apparatus, is unable to provide a standard amount of control and comfort for users of varying hand sizes. Some users may need to engage the fingertips (or DIP joints) in an unnatural fashion to hold onto the apparatus or spread the fingers to prevent shifting, creating unnecessary stress and strain on joints and muscles of the hand. The present embodiment may provide added depth, control, and comfort, which may achieve greater movement of the spine. In addition, the enclosure for the straight hand, as provided by the prior art device, may cause the over-extension of the thumb when a practitioner is attempting to locate the spine which likely ends in the use of the other hand for accuracy. Because the surface of a closed fist is more compact, it is believed that the present embodiment may position the thumb along the channel for the spine, which may improve accuracy.

FIGS. 1A, 1B, and 1C illustrate an exemplary hand guard device for use when performing manipulations of the spine, in accordance with an embodiment of the present invention. FIG. 1A is a side perspective view. FIG. 1B is a diagrammatic front view, and FIG. 1C is a diagrammatic bottom view of apparatus in place within a hand (8). In the present embodiment, a contoured block (1) is typically made of a thick material that will flex yet maintain its general shape under force. Contoured block (1) comprises multiple curves that form a sculpted palm rest (2) and flow into a finger grip indentation (3) to be gripped by practitioner. The finger grip indentation (3) ends near the bottom of the contoured block (1) with the side of one of the two raised pads (5) forming a protective ledge (4) at the base of the finger grip indentation (3). In conjunction with the finger grip indentation (3), the protective ledge (4) may protect practitioner's fingers (10) by compressing under the weight of patient and absorbing force while cushioning the fingers (10) as well as protecting patient's back from discomfort caused by practitioner's finger bones (10). When gripped, the hand (8) wraps around the contoured block (1) forming a semicircular shape, which in contrast to the use of a fist in the typical performance of the anterior adjustment, removes the practitioner's hand (8) from the area under patient where risk of compression is greatest. Raised pads (5) sit on either side of contoured block's (1) bottom forming a channel (6) that may help to prevent bone contact when pressure is added to the device. Raised pads (5) may imitate the fingers (10) and heel (15) of practitioner's fist in a regular anterior adjustment. In some embodiments, the raised pads (5) and spinal chamber (6) may comprise a single pad as a separate piece to be attached to contoured block (1) or made up of individual components connected to the contoured block (1) using adhesive or some other method and may be of a single derometer or more than one such as, but not limited to, a softer strip of material for the spine between two stiffer pads of material.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a hand guard for use when performing manipulations of the spine according to the present invention will be apparent to those skilled in the art. Various aspects of the invention have been described above by way of illustration, and the specific embodiments disclosed are not intended to limit the invention to the particular forms disclosed. The particular implementation of the hand guard may vary depending upon the particular context or application. By way of example, and not limitation, the hand guards described in the foregoing were principally directed to flexible implementations; however, similar techniques may instead be applied to hand guards that are inflexible in strategic locations to enhance patient and practitioner comfort, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed. The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a contoured block comprising a sculpted palm rest on a top surface and a finger grip indentation on a front side, said contoured block being configured to be grasped by a hand of a user with fingers on said finger grip indentation and a palm on said sculpted palm rest where a thumb of the hand is extendable to guide placement of the apparatus on a patient's spine; and
pads being disposed on a bottom surface of said contoured block, said pads being configured to form a spinal channel, said pads being further configured for contacting sides of the patient's spine with the patient's spine being positioned within said spinal channel.

2. The apparatus as recited in claim 1, further in which said contoured block comprises a generally flexible material.

3. The apparatus as recited in claim 1, in which contoured block is further configured for ambidextrous use.

4. The apparatus as recited in claim 1, in which a front side of one of said pads is further configured to form a protective ledge below said finger grip indentation.

5. The apparatus as recited in claim 1, in which said sculpted palm rest further comprises a sloped shape.

6. The apparatus as recited in claim 1, in which said contoured block further comprises a custom shape configured to a unique hand shape of the user's hand.

7. The apparatus as recited in claim 1, in which said finger grip indentation comprises a single depressed area.

8. The apparatus as recited in claim 1, in which said pads further comprise a medium derometer rubber.

9. The apparatus as recited in claim 1, in which said pads further comprise a flat surface.

10. The apparatus as recited in claim 1, in which said pads comprises a front pad and a rear pad.

11. The apparatus as recited in claim 1, in which said spinal channel further comprises a flat surface.

12. The apparatus as recited in claim 1, in which said contoured block further comprises rounded edges.

13. An apparatus comprising:
means being configured for grasping by a user's hand with fingers and knuckles of the hand forming a semi-open curve while grasping said means where a thumb of the hand is extendable to guide placement of the apparatus on a patient's spine; and
means being configured for contacting sides of the patient's spine with the patient's spine being positioned within a channel.

14. The apparatus as recited in claim 13, further comprising means for mitigating damage to the fingers and knuckles.

15. An apparatus comprising:
a contoured block comprising rounded edges, a generally flexible material, a sculpted palm rest on a top surface and a finger grip indentation on a front side, said sculpted palm rest further comprises a sloped shape, said finger grip indentation further comprises a single depressed area, said contoured block being configured to be ambidextrously grasped by a hand of a user forming a semi-open curve while grasping said contoured block with fingers on said finger grip indentation and a palm on said sculpted palm rest where a thumb of the hand is extendable to guide placement of the apparatus on a patient's spine;
pads comprising a medium derometer rubber and being disposed on a bottom surface of said contoured block, said pads further comprising a front pad and a rear pad with flat surfaces, said pads being configured to form a spinal channel comprising a flat surface, said front pad being further configured to form a protective ledge below said finger grip indentation, said pads being further configured for contacting sides of the patient's spine with the patient's spine being positioned within said spinal channel.

16. The apparatus as recited in claim 15, in which said contoured block further comprises a custom shape configured to a unique hand shape of the user's hand.
